(19) United States
(12) Patent Application Publication
(10) Pub. No.: US 2013/0246441 A1
(43) Pub. Date: Sep. 19, 2013

(54) Method for Evaluating Short to Medium Length Messages

(71) Applicant: CONGOO, LLC, Somerville, NJ (US)

(72) Inventors: Ash Nashed, Whitehouse Station, NJ (US); Joshua Lee Detweiler, Telford, PA (US)

(73) Assignee: CONGOO, LLC, Somerville, NJ (US)

(21) Appl. No.: 13/795,207

(22) Filed: Mar. 12, 2013

Related U.S. Application Data
(60) Provisional application No. 61/610,237, filed on Mar. 13, 2012.

(51) Int. Cl. G06F 17/30

(52) U.S. Cl. CPC G06F 17/30699
USPC 707/749

(57) ABSTRACT

A system and method for evaluating short messages is described. A list of messages, pre-filtered by keyword and geographic origin, are scored using a stack of filters having either general scoring parameters or flexible, user defined parameters. Each filter examines the messages for characteristics such as whether they have been re-sent, they contain particular abbreviations or repetitions, a minimum number of words, profanities or other characteristics indicative of their value to a user. A report consisting of the scored messages, i.e., the message and the score associated with the message after application of all relevant filters to the message, is then sent to a user. The report is either ordered or not, and is either an electronic or a human readable form. The elapsed time since the message was originally scored or sent is used to periodically readjust the scores and the report.

### CLAIM OF PRIORITY

This application claims priority from U.S. provisional application 61/610,237, filed on Mar. 13, 2012, the contents of which are fully incorporated by reference.

### FIELD OF THE INVENTION

The invention relates to a system and method for automatically evaluating short to medium length messages that have been generated by users and sent electronically, and more particularly, to systems and methods for automatically ranking messages according to user-customizable rules by means of a layered stack of filters.

### BACKGROUND OF THE INVENTION

User generated content is growing at an enormous and ever increasing pace. For instance, a social media site such as Twitter™ has seen the number of “tweets”, i.e., short messages, grow from 65 million tweets per day to over 200 Million tweets per day in the space of one year. A popular social media site, such as the Facebook™ website currently logs over one billion short or medium message interactions per day.

This vast number of messages are, however, mostly worthless or low value information, as anyone who reads them soon discovers.

The problem is, therefore, how to rapidly sort through all this growing Tsunami of data, using available computing power, and find only the data that is relevant to a user's current interests, concerns or requirements.

Most social media sites such as, but not limited to, Twitter™ or FaceBook™, do provide application programming interfaces (API's) to their data sets, but these tend to be simple key word searches with some facility for targeting, such as specifying the range within which the key words must be found. The available API's are, consequently very limited in their ability to obtain meaningful data in manageable amounts.

In contrast, the system of this invention is a multi-level filtering and scoring platform that allows users to identify and extract relevant, highly-targeted information that may be more useful to them and may be of a better quality.

### DESCRIPTION OF THE RELATED ART

The relevant prior art includes:

U.S. Pat. No. 7,752,159 entitled “System and method for classifying text” filed by Yoram Nelken et al on Aug. 23, 2007 that describes a system and method for classifying text that includes a pre-processor, a knowledge base, and a statistical engine. The pre-processor identifies concepts in the text and creates a structured text object that contains the concepts. The structured text object is then passed to a statistical engine, which applies statistical information provided in nodes of a knowledge base to the structured text object in order to calculate a set of match scores, each match score representing the relevance of the text to an associated one of a plurality of predefined categories. The pre-processor may be implemented in the form of an interpreter which selects and executes a script that includes language- and scenario-specific instructions for performing linguistic and semantic analysis of the text.

U.S. Pat. No. 6,665,655 entitled “Implicit rating of retrieved information in an information retrieval system allows a user to search a database of informational items for a desired informational item, and presents the search result in the form of matching index entries in the order of relevance. The information retrieval system in accordance with the principles of the present invention assigns a relevance rating to each of the index entries without requiring an explicit input from the user with respect to the usefulness or the relevance of the retrieved information corresponding to the respective index entries. When the user selects and retrieves an informational item through a list of index entries presented by the retrieval system, as a result of a search, the relevance rating of the selected informational item is increased by a predetermined amount. The relevance rating of the selected informational item is further adjusted based on any actions the user takes subsequent to the initial selection of the informational item if the subsequent act indicates that the relevance of the selected informational item may be less than what is reflected by the rating increase by the predetermined amount. Ratings of the informational items in the database are determined from implicit suggestions from the usage of the retrieval system and the database by the user rather than from an explicit user input. In another aspect of the present invention, the ratings are allowed to decay over time to minimize the tendencies for historical usage biased rating, and to provide more temporally accurate ratings. The most recently accessed time of each of the informational items in the database is compared to a predetermined stale access time threshold, and if the most recently accessed time is older than the threshold, than the rating of the corresponding informational item is decreased to reflect the dated nature of the information contained within the item.

U.S. Pat. No. 8,024,324 filed by Amitay, et al. on Sep. 20, 2011 entitled “Information retrieval with unified search using multiple facets” that describes a method for information retrieval with unified search between heterogeneous objects includes indexing a first object as a document in a search index; referencing a second object related to the first object in a facet of the document; and storing a relationship strength between the first and second objects in the facet of the document in the search index. Multiple heterogeneous objects can be related to the first object and referenced in multiple facets of the document, each with its relationship strength to the first object. Scoring an indirect object by indirect relation to a query object can be carried out by aggregating the relationship strengths between the indirect object and the retrieved objects multiplied by the retrieved objects' direct scores of relationship strength to the query object.

U.S. Pat. No. 7,930,302 filed by Bandaru et al. on Apr. 19, 2011 entitled “Method and system for analyzing user-generated content” that describes a method and system for collecting and analyzing data found across multiple sites on the internet or stored in a self-contained or pre-loaded database, is disclosed which captures, extracts, analyzes, categorizes, synthesizes, summarizes and displays, in a customizable format, both the substance and sentiment embodied within user-generated content, such as comments or reviews, found across such sites and/or stored within such databases.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to a system and method for evaluating messages.

In a preferred embodiment, the system and method for evaluating messages may begin with a pre-filtered list of one or more messages generated by one or more humans. The messages may be capable of being read either electronically or by a human.

In a preferred embodiment, each of the messages may have fewer than 10,000 characters when in human readable form. The pre-filtered list may include only messages that have automatically been deemed by a software module operative on a first suitably programmed data processing mechanism to contain at least one predefined keyword. The messages on the pre-filtered list may also have been automatically identified by the software module as having a proximity to a user predefined geographic location.

In a preferred embodiment, a second suitably programmed data processing mechanism may then be used to automatically generate a report. The report may, for instance, be one or more scored messages. Each of the scored messages may be associated with a score, and each scored message may corresponds to one of the messages of the pre-filtered list.

The scores associated with each message may, for instance, be generated, in part, using a filter stack that may for instance have several layers.

Each layer of the filter stack may be a general scoring filter having predefined parameters, or it may be a flexible parameter filter having parameters that may adjusted by the user.

In a preferred embodiment, a first general scoring filter may, for instance, automatically adjust the score of any message that is identified as being a response to another human generated message. A second general scoring filter may, for instance, automatically adjust the score of any message that is deemed to contain a human readable colloquial abbreviation such as, but not limited to, LOL or OMG, or a machine readable equivalent thereof.

A third general scoring filter may automatically adjust the score of any message that is automatically identified as having been resent by a human.

The adjustments may be user settable and may increment or decrement the score by a selected amount.

A first flexible parameter filter may adjust the score of any message that is found to have fewer than a user selected minimum number of words. A second flexible parameter filter may automatically performs a user defined adjustment to the score of any message that is found to contain a user selected word or phrase.

Once all the messages have been scored, the list of scored messages and their associated scores may be delivered as a report to a user. The report may, for instance, be in human readable form, computer readable form, or a combination thereof.

Therefore, the present invention succeeds in conferring the following, and others not mentioned, desirable and useful benefits and objectives.

It is an object of the present invention to provide a system and method for rapidly sorting through short or medium length messages by scoring each message based on a set of parameters that may be partially preset and partially user selected.

It is another object of the present invention to provide a means of identifying messages of high value to a user.

Yet another object of the present invention is to provide a system that can be expanded, or reduced, by varying the number of filters in the filter stack.

Still another object of the present invention is to be able to efficiently update a report in real time.

### BRIEF DESCRIPTION OF THE DRAWINGS

FIG. 1 shows a schematic overview of an exemplary embodiment of a system for evaluating messages in accordance with the present invention.

FIG. 2 shows a schematic flow diagram of an exemplary embodiment of a system for evaluating messages in accordance with the present invention.

FIG. 3 shows a schematic diagram of part of an exemplary embodiment of a system for evaluating messages in accordance with the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

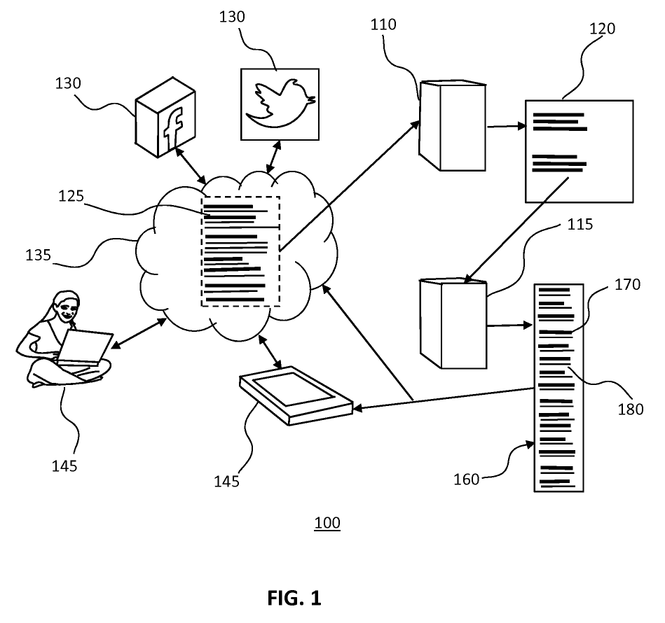

FIG. 1 shows a schematic overview of an exemplary embodiment of a system for evaluating messages in accordance with the present invention.

In a preferred embodiment, the system and method for evaluating messages 100 may evaluate messages generated by one or more humans 125. The messages may, for instance, be the result of individual users 145 who may be communicating with each other via one or more social network sites 130 accessible via a suitable communications network 135 such as, but not limited to, to the Internet or the World Wide Web. Such messages may be readable both by humans and by programmed data processing mechanisms such as, but not limited to, computers, smart phones, tablets, or some combination thereof.

In a preliminary step, a first suitably programmed data processing mechanism 110 may gather messages from the more messages generated by one or more humans 125 based on one or more predefined key words or key phrases or a combination thereof.

In a preferred embodiment, the messages gathered by the first suitably programmed data processing mechanism 110 may be 20,000 characters or less, when displayed in human readable form, and more preferably 10,000 characters or less, and may even be confined to messages that are 5,000 characters or less. Such messages may, for instance, take a specific form such as, but not limited to, a short email messages, a text message, a tweet, a social network posting or some combination thereof.

In addition to predefined keyword 140 and maximum character size, the messages in the pre-filtered list 120 may also be ones that are connected to, or related to, a predefined geographic location 150 such as, but not limited to, a zip code, a town, a state, a country, a street, a business, a franchise or some combination thereof.

The first suitably programmed data processing mechanism 110 may then organize the messages into a pre-filtered list 120 of messages. This pre-filtered list 120 may have some order such as, but not limited to, being most relevant to the keywords or the geographic location, or some combination thereof. This pre-filtered list 120 may then be forwarded on to a second suitably programmed data processing mechanism 115.

The second suitably programmed data processing mechanism 115 may then score each of the messages on the pre-filtered list 120. The score may, for instance, be obtained, in part, by passing each message through a filter stack that may for instance have several layers.

Each layer of the filter stack may be a general scoring filter having predefined parameters, or it may be a flexible parameter filter having parameters that may adjusted by the user. Once the message has been scored by all the relevant filters, the final score will then be recorded with the message in a report of scored messages.

In a preferred embodiment, a first general scoring filter 210 may, for instance, automatically adjust the score of any message that is identified as being a response to another human generated message. The determination that the message is a response may, for instance, be made by identifying one or more of the characters in a tweet such as the tweet beginning with the character “@”, having the letters “RT” at the beginning of the tweet, or containing the “retweeted” box, or some combination thereof. Other message forms may also have metadata that allow a programmed module to make a similar determination.

The message may initially be assigned a default score that may be a number such as, but not limited to, 0 or 50 or 100. The first general scoring filter 210 may be preset to add or subtract, or otherwise adjust the score, by a certain amount, depending on whether or not it is determined to be a response to another human generated message. The amount of the adjustment may be dependent on a probability that the filter has made a correct determination.

A second general scoring filter 212 may, for instance, automatically adjust the score of any message that is deemed to contain a human readable colloquial abbreviation such as, but not limited to, LOL, OMG, FU, ROTFL, LAMO, WTF?, IMHO, SNAFU, FUBAR, thx, ttyl, brb, r u, O/T or a machine readable equivalent thereof.

A third general scoring filter 214 may, for instance, automatically adjust the score of any message that is automatically identified as having been resent by a human by the second suitably programmed data processing mechanism 115 using the third general scoring filter 214.

Examples of other general scoring filters will be presented later.

Having adjusted the score using all the required elements of the general scoring filter stack 208, the message parsing and scoring module 118 operative on the second suitably programmed data processing mechanism 115 may then proceed to check if any elements of a flexible parameter filter stack 221 are required to be applied to the current message 127.

In a preferred embodiment, a first flexible parameter filter 220 may, for instance, adjust the score of any message that is found to have less than a user selected minimum number of words. A second flexible parameter filter 222 may, for instance, automatically performs a user defined adjustment to the score of any message that is found to contain a user selected word or phrase, or some combination thereof. Other examples of possible flexible parameter filters will be presented later.

Once all the messages have been score using all the appropriate or required elements of the filter stack 205, the list of scored messages and their associated scores may be delivered as a report 160 to a user. The report may, for instance, be in human readable form, computer readable form, or a combination thereof. The report may be sent on to one or more individual users 145 directly or via the communications network 135, and may be arranged in a pre-defined order such as, but not limited to, ascending order, descending order, best ten, or another quantity of messages, followed by the worst ten, or another quantity of messages, or some combination thereof.

The individual users 145 may further order or select from the report to obtain the messages most relevant to them.

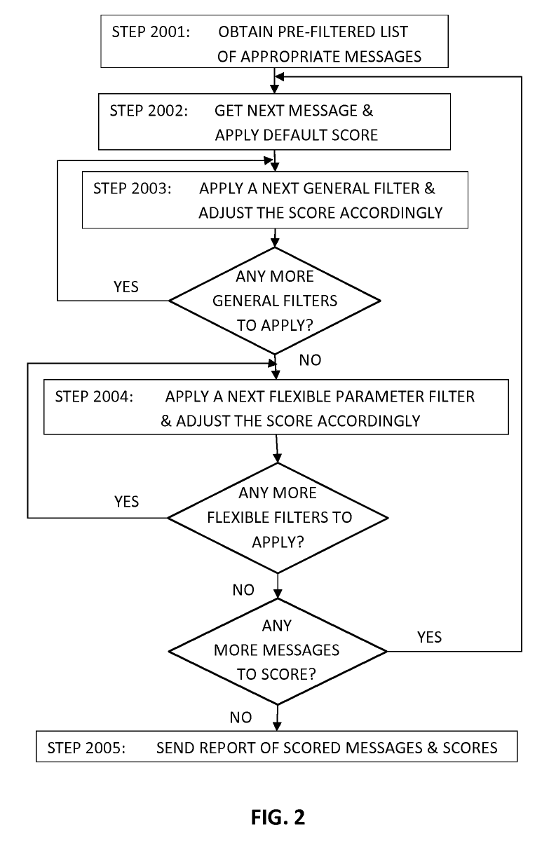

FIG. 2 shows a schematic flow diagram of an exemplary embodiment of a method for evaluating messages in accordance with the present invention. The steps in the process may include:

Step 2001: Obtain a pre-filtered list of appropriate messages. These messages may be generated by one or more humans 125 as they interact with each other via social network sites 130 over the communications network 135. The messages may have been preselected by a first suitably programmed data processing mechanism 110 using criteria such as, but not limited to, key words, key phrases, geographic location and total length of the message or some combination thereof. The messages may be arranged in a pre-filtered list 120, which is the list obtained by a second suitably programmed data processing mechanism 115. In an alternate embodiment, the first and second suitably programmed data processing mechanism 115 may be one device that may be operating one or more data processing modules that automatically process the messages.

Step 2002: Get next message and apply a default score. In this step, a software or hardware module running on the second suitably programmed data processing mechanism 115 begins taking messages from the pre-filtered list 120 in order to score them. As a part of this step, the second suitably programmed data processing mechanism 115 may initially assign a default score to the current message being scored.

Step 2003: Apply a next general filter to the message and adjust the score accordingly. In this step, the second suitably programmed data processing mechanism 115 may apply a general filter to the message. This general filter may, for instance, automatically parse the electronic form of the message looking to see if it has some attribute, or contains a particular set of symbols such as, but not limited to, that it is a response to another human generated message, it contains a colloquial abbreviation, it has been resent, it contains a profanity, a blasphemy or an ethnic slur, or what may perceived as such by a recognized religion organization or a particular ethnic group, or if it contains a personal pronoun or some combination thereof.

As a next step, the message parsing and scoring module 118 operative on, for instance, the second suitably programmed data processing mechanism 115 may, having scored the message using a first general scoring filter 210, check to see if there are further elements of the general scoring filter stack 208 that need to be used such as, but not limited to, a second general scoring filter 212, a third general scoring filter 214, a forth general scoring filter 216 or a fifth general scoring filter 218, or some further general filters or some combination thereof.

If there is another element of the general scoring filter stack 208 that need to be applied, the message parsing and scoring module 118 may proceed to apply it to the current message 127 and adjust the message score accordingly.

If there are no further elements in the general scoring filter stack 208 that need to be applied to the current message, the message parsing and scoring module 118 may proceed to check if there are any elements of the flexible parameter filter stack 221 that need to be applied to the current message 127. If there are, the message parsing and scoring module 118 may proceed to step 2004.

Step 2004: Apply a next flexible parameter filter and adjust the score accordingly. A flexible filter may, for instance, be examine the current message 127 to ascertain if it has some attribute or it contains a particular set of symbols such as, but not limited to, a user selected word or phrase, that it contains a word longer than a user selected number of characters when in human readable form, it contains any character repeated more than a user selected number of times or a user selected character repeated more than a user selected number of times, or that it emanates from, or appears to emanate from a user selected geographical location or a user selected time or date, or some combination thereof.

The message parsing and scoring module 118 may, for instance, apply a first flexible parameter filter 220 that that automatically adjusts the score of any message that is to have fewer than a user selected minimum number of words.

Having scored the message using the first flexible parameter filter 220, the message parsing and scoring module 118 may then check to see if there are any further elements of the flexible parameter filter stack 221 that need to be applied to the current message 127. If there are further elements to be applied, the message parsing and scoring module 118 may then apply them.

As a next step, for instance, the message parsing and scoring module 118 operative on, for instance, the second suitably programmed data processing mechanism 115 may, having scored the message using a first flexible parameter filter 220, check to see if there are further elements of the flexible parameter filter stack 221 that need to be used such as, but not limited to, a second flexible parameter filter 222, a third flexible parameter filter 224, a forth flexible parameter filter 226 or a fifth flexible parameter filter 228, or some further flexible parameter filters or some combination thereof.

If there are no further elements of the flexible parameter filter stack 22, the message parsing and scoring module 118 may then check to see if there are any further messages that need to be scored. If there are further messages, the message parsing and scoring module 118 may then return to step 2002, obtain the next message and proceed to follow the flow chart from there as described above.

If there are no further messages to score, the message parsing and scoring module 118 may then proceed to step 2005.

Step 2005: Send report of scored messages with scores. In this step, the message parsing and scoring module 118 or a report generating module 117, or some combination thereof, may then set a report 160 onto an end user, or an intermediary who may use the report 160 as part of a further application or API.

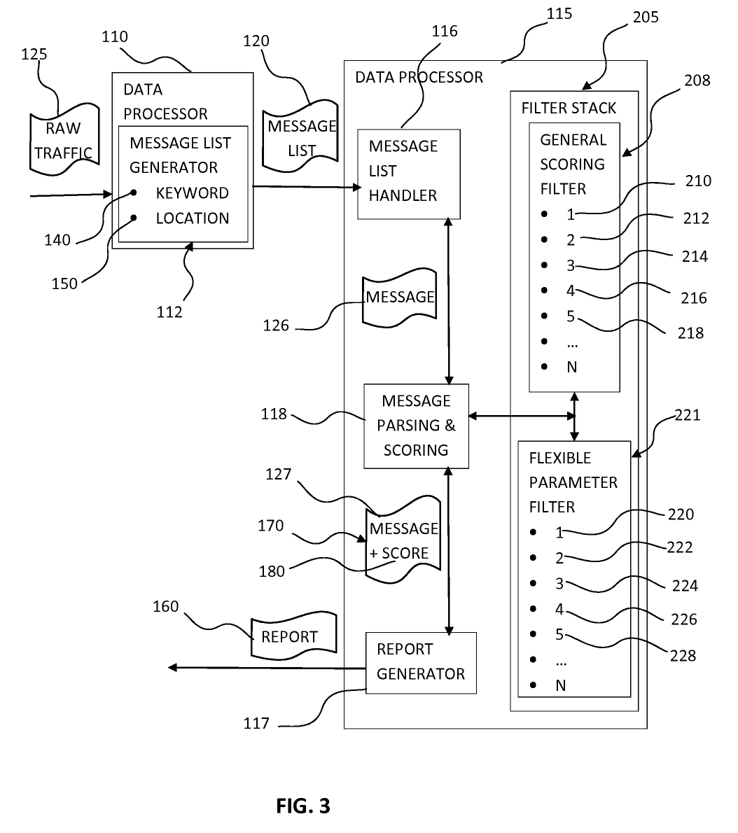

FIG. 3 shows a schematic diagram of part of an exemplary embodiment of a system for evaluating messages in accordance with the present invention.

Raw traffic, i.e., the messages generated by one or more humans 125 that is flowing across a communications network 135 such as, but not limited to, the World Wide Web (WWW) on the Internet, may be monitored by a message list generating module 112 operative on a first suitably programmed data processing mechanism 110. The message list generating module 112 may, for instance, monitor the messages in order to select out those have characteristics such as, but not limited to, one or more particular predefined keywords 140, or those messages emanating from, or in the vicinity of, a predefined geographic location 150 or some combination thereof.

The message list generating module 112 may then process those monitored messages to produce a pre-filtered list 120 of messages. This pre-filtered list 120 may then be passed on to a message list handling module 116 operative on a second suitably programmed data processing mechanism 115.

One of ordinary skill in the art will readily appreciate that although the process may be described in terms of a message list generating module 112 and a message list handling module 116 operative respectively on a first and a second suitably programmed data processing mechanism, the concept may instead be implemented using a single data processing unit or more than two data processing units. Similarly, although the process is illustrated here with a separate message list generating module 112 and a separate message list handling module 116, the same, or functionally equivalent, functions may be combined into a single module or split into more than two modules. One of ordinary skill in the art will further appreciate that the functionality of these modules, as with the other functional modules described in this application, may be implemented as software, firmware, hardware, or some combination thereof.

The message list handling module 116 may then select a current message 127 from the pre-filtered list 120 and forward the message in suitable electronic form 126 to a message parsing and scoring module 118 that may also be operative on the second suitably programmed data processing mechanism 115.

The message parsing and scoring module 118 may then score the message using one or more filters obtained in a filter stack 205. In a preferred embodiment, the filter stack may contain both a general scoring filter stack 208 and a flexible parameter filter stack 221.

The general scoring filter stack 208 may, for instance, contain filters in which arguments or parameters are “factory set”, i.e., pre-selected by an organization such as, but not limited to, the organization responsible for producing or distributing the filter stack 205 software or hardware, or by the organization operating the second suitably programmed data processing mechanism 115 or some combination thereof.

The flexible parameter filter stack 221 may, for instance, contain filters in which one or more of the arguments or parameters relevant to the filter may be selected by an individual such as, but not limited to, an operator, or a user, of the second suitably programmed data processing mechanism 115 or an operator, or a user, of the relevant software or hardware modules operation on the second suitably programmed data processing mechanism 115, or some combination thereof.

In further embodiments the filter stack 205 may contain other types of filter stacks such as, but not limited to, filters in which one or more of the parameters are set by a group of users or by the result of voting by users or as a consequence of a contest between users or a group of users, or some combination thereof. These groups of users may, for instance, be users that are participating in an event such as, but not limited to, watching or participating in a television show, participating in a social network interaction or message thread, or participating in an online game or some combination thereof.

Examples of a general scoring filter may be filters such as, but not limited to, a first general scoring filter 210 that adjusts the score of any pre-filtered message that is a response to another message and contains at least one @ sign; a second general scoring filter 212 that automatically adjusts the score of any message that is automatically deemed to contain a human readable colloquial abbreviation; a third general scoring filter 214 that automatically adjusts the score of any message that is automatically identified as having been resent; a forth general scoring filter 216 that adjusts the score of any pre-filtered message that contains a profanity; or a fifth general scoring filter 218 that adjusts the score of any pre-filtered message that contains a personal pronoun, such as, but not limited to, a pronoun selected from the set I, us and our; or a filter that may incorporates some suitable combination of such or related elements.

Examples of a flexible parameter scoring filter may be filters such as, but not limited to, a first flexible parameter filter 220 that automatically adjusts the score of any message that is automatically deemed to have fewer than a user specified number of words or characters; a second flexible parameter filter 222 that automatically performs a user defined adjustment to the score of any message that is automatically deemed to contain a user selected word or phrase; a third flexible parameter filter 224 that performs a user defined adjustment to the score of any pre-filtered message that begins with a user selected word or phrase; a forth flexible parameter filter 226 that performs a user defined adjustment to the score of any pre-filtered message that contains word longer than a user selected length; a fifth flexible parameter filter 228 that performs a user defined adjustment to the score of any pre-filtered message that contains a sequence of a repeated character longer than a user selected length; or a filter that may incorporates some suitable combination of such or related elements.

The message parsing and scoring module 118 may then pass on the scored messages 170, i.e., the current message 127 and the final score 180 associated with that message after all the relevant filters have been used to adjust the score of that message, on to a report generating module 117 that may also be operative on the second suitably programmed data processing mechanism 115.

The report generating module 117 may then generate a report 160. In a preferred embodiment, the report 160 may consist of all the messages on the pre-filtered list 120, each associated with a score that may be supplied by the message parsing and scoring module 118.

The report 160 may be unordered, ordered in ascending or descending order of score, ordered alphabetically, order by the original time of sending the message, or some combination thereof.

Either the message parsing and scoring module 118 or the report generating module 117, or some combination thereof, may also periodically rescore the messages by automatically adjusting the score based on a length of time since said message was originally scored or sent, and automatically update the report. If the report is ordered, the report generating module 117 may also automatically update the ordering of the report.

The report generating module 117 may then send the report 160 on to an end user or a user who may incorporate the report, or elements thereof, into an application or API or some combination thereof. The report 160 may be sent in a format such as, but not limited to, an electronic format or human readable format, or some combination thereof.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method for evaluating messages, comprising:
providing a pre-filtered list of one or more messages generated by one or more humans, and capable of being read either electronically or by a human, and wherein each of said messages has fewer than 10,000 characters when in human readable form, and wherein each of said messages is automatically deemed by a first software module operative on a first suitably programmed data processing mechanism to contain at least one predefined keyword, and is automatically identified by said software module as having a proximity to a user predefined geographic location;
using a second suitably programmed data processing mechanism to automatically generate a report comprising one or more scored messages, each scored message being associated with a score, wherein each scored message corresponds to one of said messages of said pre-filtered list, and wherein each of said scores is generated, in part using a filter stack, comprising:
a first general scoring filter that automatically adjusts the score of any message that is automatically identified as being a response to another human generated message by said first general scoring filter;
a second general scoring filter that automatically adjusts the score of any message that is automatically deemed by said second general scoring filter to contain a human readable colloquial abbreviation that is either LOL or OMG, or a machine readable equivalent thereof;
a third general scoring filter that automatically adjusts the score of any message that is automatically identified by said third general scoring filter as having been resent by a human;
a first flexible parameter filter that automatically adjusts the score of any message that is automatically deemed, by said first flexible parameter filter, to have fewer than a user selected minimum number of words;
a second flexible parameter filter that automatically performs a user defined adjustment to the score of any message that is automatically deemed by said second flexible parameter filter to contain a user selected word or phrase; and
delivering said report to a user.

2. The method for evaluating messages of claim 1, further comprising a forth general scoring filter that automatically adjusts the score of any message that is automatically deemed by said forth general scoring filter to contain a profanity.

3. The method for evaluating messages of claim 2 further comprising a fifth general scoring filter that automatically adjusts the score of any message that is deemed by said fifth general scoring filter to contain a personal pronoun selected from the human readable set I, us and our, or an electronic equivalent thereof.

4. The method for evaluating messages of claim 3, further comprising a third flexible parameter filter that automatically performs a user defined adjustment to the score of any message that is automatically deemed by said third flexible filter to begin with a user selected word or phrase.

5. The method for evaluating messages of claim 4, further comprising a forth flexible parameter filter that automatically performs a user defined adjustment to the score of any message that is automatically deemed by said forth flexible parameter to contain a word that in human readable form exceeds a user selected number of characters.

6. The method for evaluating messages of claim 5 further comprising a fifth flexible parameter filter that automatically performs a user defined adjustment to the score of any message that is automatically deemed by said fifth flexible parameter filter to contains a sequence of repeated characters, in either readable or electronic form, that exceeds a user selected number.

7. The method for evaluating messages of claim 1 further comprising automatically generating said report in either ascending or descending order of the score the scored messages.

8. The method for evaluating messages of claim 7 further comprising automatically, periodically rescoring said messages by automatically adjusting the score based on a length of time since said message was originally scored, and automatically updating said report in either ascending or descending order of the updated score of each of said messages.

9. A system for evaluating messages, comprising:
a data processing mechanism programmed to perform the functions of:
obtaining a pre-filtered list of one or more messages generated by one or more humans, and capable of being read either electronically or by a human, and wherein each of said messages has fewer than 10,000 characters when in human readable form, and wherein each of said messages has been deemed to contain at least one predefined keyword, and is automatically identified by said software module as having a proximity to a user predefined geographic location;
automatically generating a report comprising one or more scored messages, each scored message being associated with a score, wherein each scored message corresponds to one of said messages of said pre-filtered list, and wherein each of said scores is generated, in part using a filter stack, comprising:
a first general scoring filter that automatically adjusts the score of any message that is automatically identified as being a response to another human generated message by said first general scoring filter;
a second general scoring filter that automatically adjusts the score of any message that is automatically deemed by said second general scoring filter to contain a human readable colloquial abbreviation that is either LOL or OMG, or a machine readable equivalent thereof;
a third general scoring filter that automatically adjusts the score of any message that is automatically identified by said third general scoring filter as having been resent by a human;
a first flexible parameter filter that automatically adjusts the score of any message that is automatically deemed, by said first flexible parameter filter, to have fewer than a user selected minimum number of words;
a second flexible parameter filter that automatically performs a user defined adjustment to the score of any message that is automatically deemed by said second flexible parameter filter to contain a user selected word or phrase; and
delivering said report to a user.
